(19) United States
(12) Patent Application Publication
(10) Pub. No.: US 2013/0255131 A1
(43) Pub. Date: Oct. 3, 2013

(54) Floating Fishing Handle Assembly

(71) Applicants: Daniel Sean Abbey, Jacksonville, FL (US); John Francis Elomaa, Jacksonville, FL (US)

(72) Inventors: Daniel Sean Abbey, Jacksonville, FL (US); John Francis Elomaa, Jacksonville, FL (US)

(73) Assignees: John Francis Elomaa, Jacksonville, FL (US); Daniel Sean Abbey, Jacksonville, FL (US)

(21) Appl. No.: 13/437,144

(22) Filed: Apr. 2, 2012

(51) Int. Cl. A01K 87/08

(52) U.S. Cl. 43/23

(57) ABSTRACT

The Floating Fishing Handle Assembly invention enables a rod to float with the reel attached. The making of the handle assembly includes use of a urethane foam, flocked rubber grip heat shrink tubing, two part epoxy and EVA foam.

### BACKGROUND OF THE INVENTION

Classification 43/4; This invention deals with the catching of fish.

Our fishing rod invention came about due to a series of events over a two week period. It started on a fishing trip with a good friend. He fell from his kayak and took one of his rods overboard with him. He dropped the rod and it sank to the bottom of eight foot deep water. We looked for that rod for two hours before we gave up the search. When we got back that afternoon, we ran into a friend who, in a strange coincidence, had also lost his rod that day. A few days later while out fishing by myself, I paddled around the bend in a creek and saw something sitting on the mud bank up ahead of me. It was low tide and with our six foot tide swings in Jacksonville, Fla., the now exposed bank was 5 foot deep for half of the day. It was a rod and reel just sitting on the bank that someone had lost. From the looks and condition of it the rod, it appeared to have been lost just a few days prior. The following week while at work (at a big box outdoors store) I had a customer who had come in to buy some new rods and reels to replace the ones his son had lost a few weeks prior. When I asked him what happened to the rods he told me that his son had flipped his kayak and lost everything overboard. This is when we started to think of how we could keep this from happening to people and what we could come up with to improve the fisherman's experience.

### SUMMARY OF THE INVENTION

The invention is a rod that will float with the reel attached and not just sink to the bottom to be lost forever. We have come up with a way to use different materials than what is currently used with typical rod construction that will allow the entire outfit to stay on top of the water so it can be easily retrieved.

### BRIEF DESCRIPTION OF DRAWINGS

The drawings show two views of the handle assembly that allows the rod to float; what makes this invention unique.

FIG. 1 is the view of the actual handle. #1 is the EVA foam butt cap. It is a decorative finish but also seals the rod end. #2 shows the rear grip of the actual handle assembly and where most of the floatation is achieved from. #3 is the reel seat. These are pre-assembled and purchased from a distributor. #4 is the foregrip of the handle assembly and where more floatation is achieved for the rod and reel. #5 is a front winding check that is made from EVA foam. #6 is the rod blank.

FIG. 2 shows the cross section of the handle assembly. #7 is the EVA butt grip again showing how it caps off the hollow end of the rod blank. #8 is the two part urethane foam that allows for the floatation, it is covered by #9 which is a flocked rubber heat tubing cover which gives the rod a comfortable grip and finished covering. #10 is the rod blank set into the handle assembly. #11 is a cross section of the reel seat. #12 shows the two part urethane foam in the foregrip which aids in add bona! floatation. #13 is the flocked rubber covering on the foregrip. #14 is the cross section of the front winding check made of EVA foam.

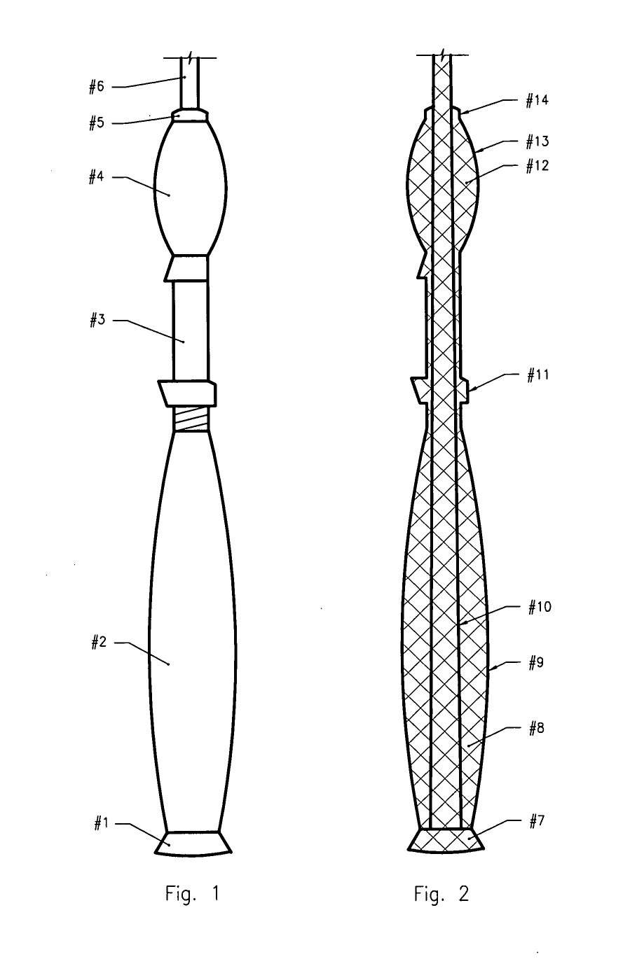

### DETAILED DESCRIPTION OF THE INVENTION

In order to achieve the ability of floatation of the rod and reel, we have made a handle assembly from different materials than the current fishing handles on the market that allow the rod the ability to be fished as a normal rod and reel and still be comfortable in your hands but also allow it the unique ability to float if it ends up in the water. The making of the handle assembly starts by mixing a batch of two part urethane foam and pouring it into a 2 inch by 2 inch by 18 inch long mold made of stainless steel. The foam is allowed to cure and is then pulled from the mold and cut into two pieces for the foregrip and reargrip of the handle. These two pieces vary in size for different applications but the rear grip is always at least two thirds of the length. The pieces are then placed into a lathe and turned to exact dimensions for each rod type. (We will be using a computerized cnc style machine as we progress.) When the foam for the foregrip and rear grip are turned to its handle shape, we then place a piece of flocked rubber grip heat shrink tubing over each piece of the foam and shrink it with a heat gun to give it a tight form fitting finish, Once the foam handles are finished, we then take and assemble the handle on the rod blank. We slide the reargrip on first and glue it on the bottom of the blank with a two part epoxy. The next piece is the reel seat which is slid down the blank and also glued on with a two part epoxy and slide down to meet the reargrip. The foregrip is put on next and glued down where it meets the reel seat. The EVA winding check that finishes off the top of the handle assembly is then slid down the blank and epoxied in place above the foregrip. The final piece of the assembly is the rear butt piece of EVA foam which finishes off the bottom of the reel and plugs the end of the rod blank. It is epoxied over the rear section of rod and the rear grip of the handle assembly. This completes the handle assembly which allows the rod to float with a reel attached. The rest of the rod is manufactured like of the other rods on the market by attaching the guides and tip top to complete the rod.

1. The floating fishing handle assembly enables a fishing rod to float with a reel on it (reels of differing sizes and styles may be attached in the reel seat).
